(19) United States
(12) Patent Application Publication
(10) Pub. No.: US 2012/0299309 A1
(43) Pub. Date: Nov. 29, 2012

(54) FACILITY FOR PRODUCING ELECTRIC CURRENT USING SOLAR RADIATION, AND METHOD FOR SECURING A BUILDING PROVIDED WITH SUCH A FACILITY

(75) Inventors: Franck Sarrus, Saint Bonnet de Mure (FR); Jean-Louis Gelet, Saint Bonnet de Mure (FR); Thierry Rambaud, Genas (FR)

(73) Assignee: MERSEN FRANCE SB SAS, SAINT-BONNET-DE-MURE (FR)

(21) Appl. No.: 13/503,979

(22) PCT Filed: Oct. 28, 2010
(86) PCT No.: PCT/FR10/52317

§ 371 Date: Jun. 22, 2012

(30) Foreign Application Priority Data
Oct. 28, 2009 (FR) 0957556

(51) Int. Cl. H02N 99/00

(52) U.S. Cl. 290/1 R

(57) ABSTRACT

The invention relates to a facility (20) for producing electric current using solar radiation, which is built into a building (1) and includes at least one photovoltaic generator (22) as well as a short-circuiting switch (80) suitable for establishing and maintaining a short-circuit across the terminals (24, 26) of the photovoltaic generator (22) by means of an electrically conductive connector. The short-circuiting switch (80) is activated by a control means (66) arranged in a pre-determined portion (60) of the building (1) or the surroundings thereof. According to the security method of the invention, a short-circuit is established and maintained across the terminals (24, 26) of the photovoltaic generator (22) by means of an electrically conductive connector, thus preventing a power grid (4) specific to the building from remaining supplied with current and live.

The present invention relates to a facility for producing electric current using solar radiation, such a facility being integrated into a building that can be used for residential, industrial, or commercial purposes.

In such a facility, several photovoltaic generators, most often called “photovoltaic panels,” are generally used to convert part of the solar radiation that reaches them into electric current. Such a facility can be used to supply electric current to the building in which it is integrated, in parallel to a public distribution grid managed by an operator, such as Electricite de France (EDF). The surplus production of such a facility can be resold to that operator by reinjecting that surplus into the distribution grid.

In the event of danger for the occupants of such a building, for example in case of fire, it is known to cut the electric current supply of the building from the public grid by maneuvering a general switch located at the interface between that grid and a distribution circuit specific to the building or upstream of that interface, on the grid. Even after such a securing intervention, the photovoltaic generator(s) can discharge an electric current that circulates in the electric circuit specific to the building, even when the emergency services believe they can work in a building whereof the electric devices are not live. This results in a risk for the people then working in the building, in particular firefighters or members of specialized services for the energy distribution operators, whether in electric or in gas form.

It is known, in particular from document DE-A-10 2005 018 173, to establish a short circuit at the terminals of a photovoltaic facility in case of danger. This technique uses electronic triggering of a thyristor and an electronic circuit supplied with current. In the case where the photovoltaic panels no longer produce current, the thyristor opens and the short circuit is not maintained, which poses security problems, in the same way the use of electronic components exposes one to the risk of destruction by fire. Furthermore, the described device comprises electronic components consuming non-negligible amounts of energy.

The invention aims more particularly at resolving these drawbacks by proposing a new electric current facility making it possible to maintain the short circuit once it is established, and not to depend on the operation of electronic components.

To this end, the invention relates to a facility for producing electric current using solar radiation, this facility being built into a building and including at least one photovoltaic generator, and a short-circuiting switch suitable for establishing and maintaining a short-circuit across the terminals of the photovoltaic generator. This facility is characterized in that this short-circuiting switch is adapted to maintain the short circuit using an electrically conductive connector bridge, and in that the short-circuiting switch is activated by a control means arranged in a predetermined portion of the building or the surroundings thereof.

Owing to the invention, the emergency or security services, who must intervene in a building equipped with an electricity production facility according to the invention, can be certain that the short-circuiting switch is indeed maintained when they enter the building. The maintenance being ensured by a mechanical part, the reliability of the short-circuiting switch is improved relative to that of the known materials. In particular, a temperature increase does not risk making the security device non-operational, as would be the case if one were to count only on the electronic components.

According to advantageous but non-mandatory aspects of the invention, such a facility can incorporate one or more of the following features, according to any technically possible combinations:
The predetermined portion of the building also contains means for monitoring the supply of current from a public distribution grid for electric current. Thus, the emergency services can maneuver, from the same site, both the means for monitoring the supply of current to the building from the public grid and the short-circuiting switch.
The predetermined portion of the building also contains means for monitoring the supply of gas from a public gas distribution grid or a tank.
The facility also comprises a converter for converting direct current into alternating current and the short-circuiting switch is mounted so that it establishes or maintains simultaneously, using the electrically conductive connector, the short circuit across the terminals of the photovoltaic generator and across the terminals of the current converter. Thus, the short-circuiting of the photovoltaic generator causes the short-circuiting of the converter. The possible source of residual electric voltage constituted by the converter is thus eliminated and the potentially resulting risks are eliminated.
The short-circuiting switch is actuated from an energy source distinct from the energy grid of the building. This makes it possible to maneuver the short-circuiting switch even when the building is no longer supplied with electric current by the grid. In that case, the energy source can be electric, for example made up of a battery, and the short-circuiting switch can comprise an electric actuator supplied from that source. It is in particular possible to provide that the electric energy source is supplied with current by the photovoltaic generator during normal operation of the facility. Alternatively, the energy source is pneumatic and the short-circuiting switch comprises a pneumatic actuator powered from that source.
The short-circuiting switch is mechanically actuated by a member connected to the aforementioned control means or by a member that can be actuated locally, close to the short-circuiting switch.
The facility also comprises means for signaling the implementation of the short-circuiting switch. This signaling means is advantageously arranged in the predetermined portion of the building. Alternatively, this signaling means is arranged close to the short-circuiting switch.

The invention also relates to a method for securing a building equipped with a facility as mentioned above and, more specifically, a method for securing a building equipped with a facility for producing electric current from the solar radiation, this facility comprising at least one photovoltaic generator. This method is characterized in that it comprises a step consisting of establishing and maintaining, using an electrically conductive connector bridge, a short circuit across the terminals of the photovoltaic generator.

Once the method according to the invention is implemented, the photovoltaic generator no longer constitutes a current source for the materials that are usually connected on that generator or on an electric circuit containing that generator, so that these materials are not live and do not risk constituting sources of danger for people intervening in the building after it has been secured.

The invention will be better understood, and the other advantages thereof will appear more clearly, in light of the following description of four embodiments of a facility for producing electric current and a method for securing a building according to its principle, provided solely as an example and done in reference to the appended drawings, in which:

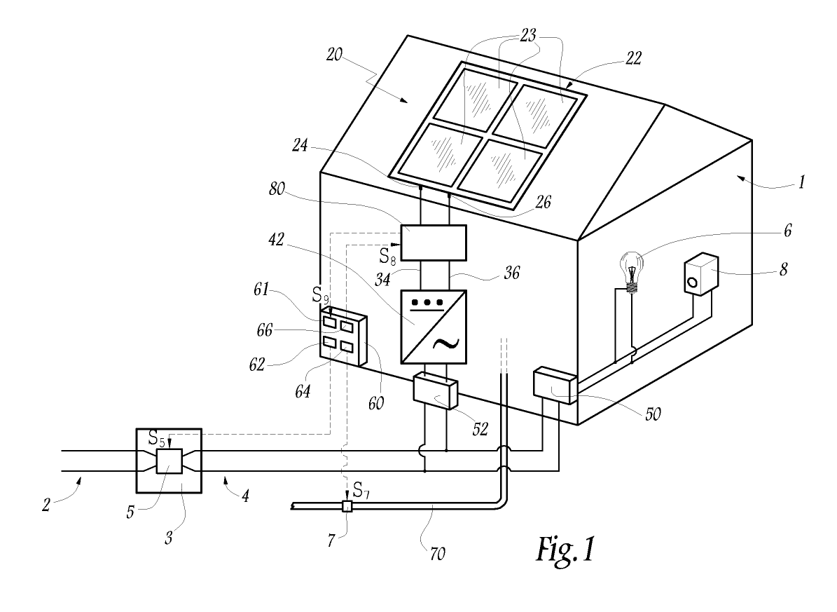

FIG. 1 is a diagrammatic principle illustration of a building equipped with a facility according to the invention;

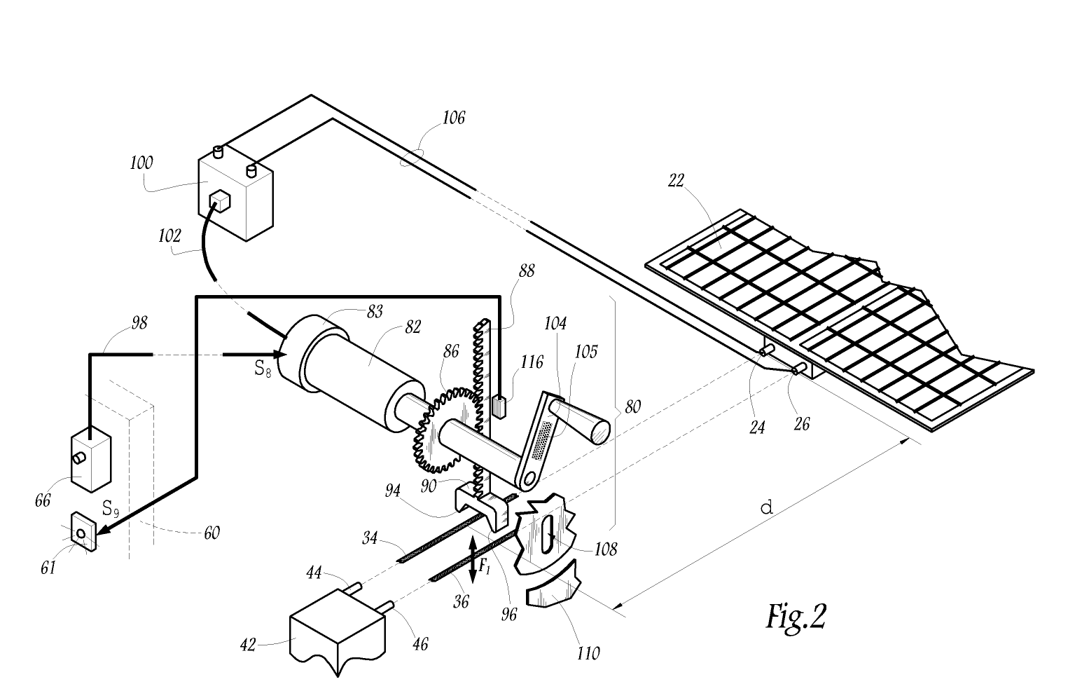

FIG. 2 is a diagrammatic principle illustration in perspective view of a portion of the facility of FIG. 1;

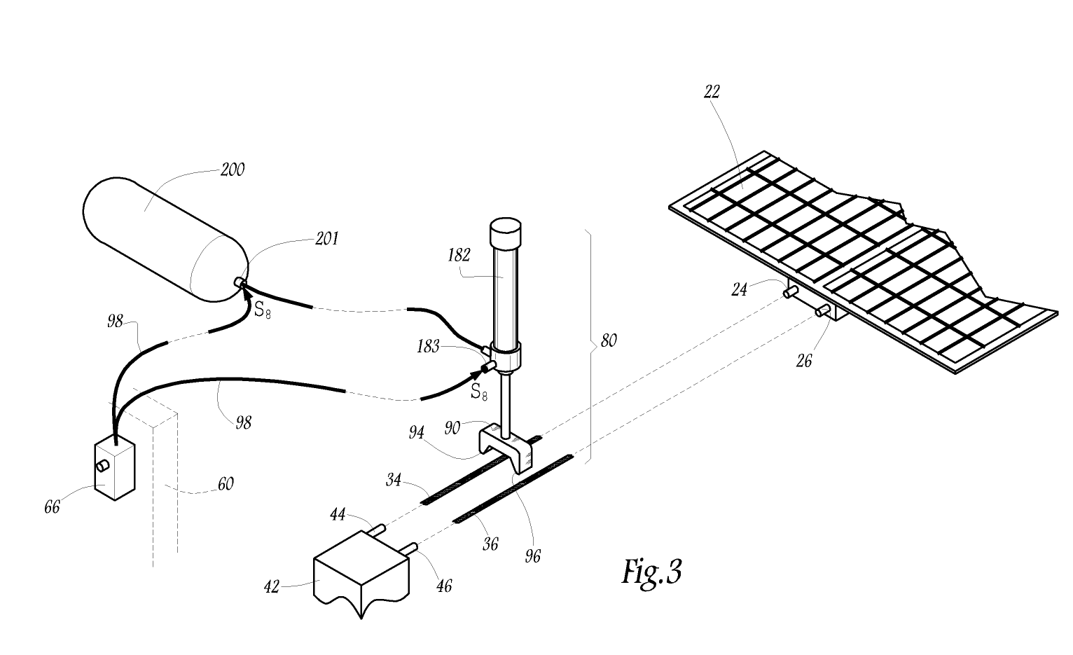

FIG. 3 is a view similar to FIG. 2, for a facility according to a second embodiment of the invention;

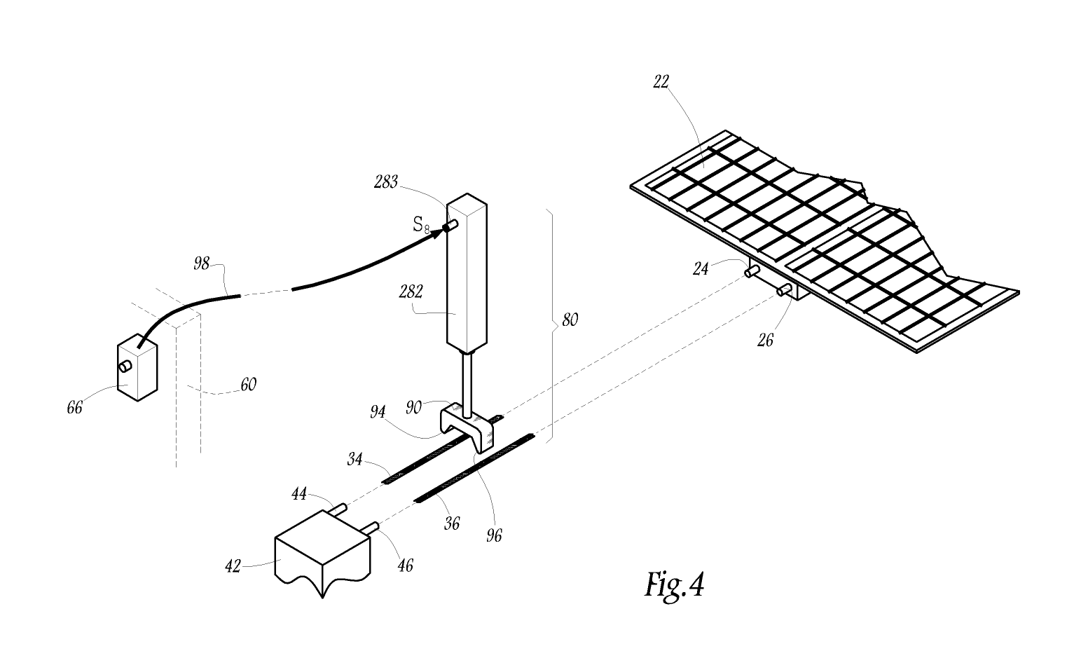

FIG. 4 is a view similar to FIG. 2, for a facility according to a third embodiment of the invention; and

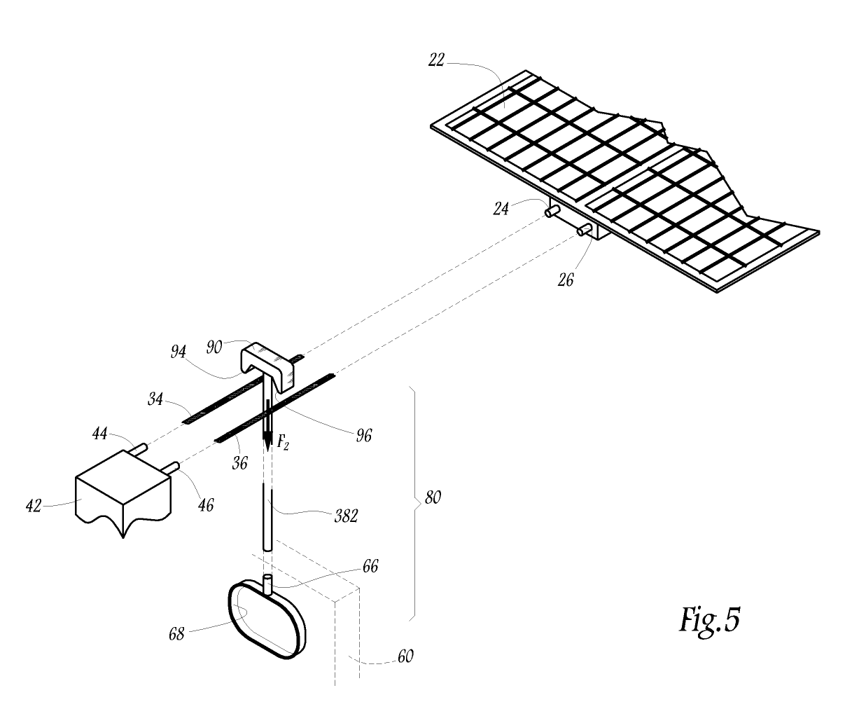

FIG. 5 is a view similar to FIG. 2, for a facility according to a fourth embodiment of the invention.

The individual house 1 shown in FIG. 1 is supplied with electric current from a public current distribution grid 2 managed by an operator, such as EDF in France. The grid 2 extends to a junction box 3 in which is arranged, inter alia, a disconnecting switch 5 making it possible to interrupt the electric connection between the grid 2 and a grid 4 specific to the house and that supplies, via a distribution pillar 50, several electric charges, such as an incandescent bulb 6 and a washing machine 8.

The house 1 is equipped with an electricity production facility 20 using solar radiation. The facility 20 comprises a photovoltaic generator that assumes the form of a panel 22 equipped with modules 23 each suitable for converting part of the radiation that reaches them into electric current. The various modules 23 of the generator 22 are electrically connected to each other at two terminals 24 and 26 of the generator 22, from which two conductive tracks 34 and 36 extend that extend as far as the inlet terminals 44 and 46 of a current converter 42 suitable for converting a direct electric current flowing in the tracks 34 and 36 into an alternating current, which can be reinjected on the grid 4 via a distribution pillar 52.

A control housing 60 is provided in the house 1, and contains control members that can be used during securing of the house 1, for example in case of fire. The housing 60 is advantageously accessible from outside the house 1. Alternatively, if the house 1 is situated on a property enclosed by walls, the housing 60 can be integrated into one of those walls.

A control member 62 is mounted in the housing 60 and monitors the disconnecting switch 5 via a signal S₅ transmitted by any suitable means, for example an electric connection. Thus, in case of actual or imminent accident in the house 1, it is possible to cut the electric connection between the grids 2 and 4, using the member 62 and the disconnecting switch 5. A second control member 64 is integrated into the housing 60 and makes it possible to control a valve 7 mounted on a natural gas supply pipe 70 of the house 1. The pipe 70 can extend from a public gas distribution grid or a tank, such as a tank positioned off the ground or underground in the yard of the house 1. A signal S₇ emitted by the member 64 is transmitted to the valve 7 using any suitable means, in particular an electric line. Here again, the member 64 makes it possible to limit the risks of fire by cutting the arrival of gas in the house 1.

The housing 60 comprises a third control member 66 that controls a short-circuiting switch 80, this short-circuiting switch being provided, if necessary, to short circuit the tracks 34 and 36 close to the terminals 24 and 26.

The short-circuiting switch 80 comprises a brushless electric motor 82, whereof the output shaft 84 is equipped with a pinion 86 engaged with a rack 88, secured to an electrically conductive connector bridge 90. Thus, by actuating the motor 82, it is possible to move the connector bridge 90 in the direction of double arrow F₁ in FIG. 2, i.e. perpendicular to the tracks 34 and 36, such that two shoes 94 and 96 belonging to the connector bridge 90 can be selectively and simultaneously brought into contact with or moved away from the tracks 34 and 36. When the shoes 94 and 96 are in contact with the tracks 34 and 36, they produce a short circuit between the output terminals 24 and 26 of the generator 22. Under those conditions, the current from the generator 22, which can be considered as a current generator at least upon first approximation, flows through the connector 90, without progressing in the tracks 34 and 36, toward the converter 42.

For safety reasons, the contact between the shoes 94 and 96 of the connector bridge 90 and the tracks 34 and 36 is done at a small distance d from the terminals 24 and 26 of the generator 22. This makes it possible to minimize the portion of the tracks 34 and 36 still supplied with current after implementing the short-circuiting switch 80. In practice, the distance d is smaller than 20 cm.

Once the short circuit is established, an outside intervention is necessary to reestablish the passage of the current, so that the connector bridge 90 is automatically kept in contact with the tracks 34 and 36.

The motor 82 is equipped with a control plate 83 on which an electrical conductor 98 is connected for transmitting a control signal S₈ emitted by the member 66 to the short-circuiting switch 80. Alternatively, the transmission of the signal S₅ between the member 66 and the short-circuiting switch can take place through a wireless connection, for example a radio link. This approach is favored when one equips an existing building with a facility according to the invention because it avoids having to pull an electric line between the housing 60 and the short-circuiting switch 80.

A battery 100 is connected to the plate 83 by an electric line 102 and constitutes a source of electric energy for the motor 82. During normal operation of the facility 20, the battery 100 is supplied with electric current from the terminals 24 and 26 of the generator 22 by a bifilar line 106, which ensures that this battery is continuously charged, to the point that it can deliver a direct voltage to the motor 82, when the latter must be activated. The battery 100 therefore constitutes a distinct energy source from the grids 2 and 4 for the motor 82.

The housing 60 constitutes a predetermined portion of the house 1 in that it involves a portion of the house that the emergency services know and which they can access to secure the house before intervention. Such a predetermined portion of the house 1 is identified on the fire safety map of the house 1 and/or identified by a door with a particular easily recognizable color or sign. Its location is generally known by the security services because it has been identified before an intervention, in particular during fire drills.

The operation is as follows: when the house 1 needs to be secured, for example in case of fire, a firefighter or security agent who accesses the control housing 60 can actuate the control members 62, 64 and 66 to electrically isolate the house 1 from the grid 2, cut the gas supply and short circuit the terminals 24 and 26 of the photovoltaic generator 22. In this way, it is possible to guarantee that no electric current is circulating in the electric grid 4, which limits the risks to which the firefighters and other people having to intervene in the house 1 are exposed. Inasmuch as the short circuit is ensured by a mechanical part and not by electronic components, the maintenance of the short circuit is guaranteed as long as an outside intervention does not reestablish the circulation of current in the tracks 34 and 36, by eliminating the contact between the connector bridge 90 and the tracks, and the risk of accidental deactivation or deactivation through destruction of electric components is low.

A handle 104 is secured to the pinion 86, which also makes it possible to maneuver the connector bridge 90 manually, in particular in the event an accident in progress in the house 1 prevents the motor 82 from operating correctly or prevents the transmission of a control order between the member 66 and the plate 83.

Access to the housing 60 is controlled by a lock whereof the key is only available to emergency resources.

Since the battery 100 is now charged owing to the line 106, it is possible to maneuver the motor 82, including after cutting of the power for the grid 4 by the disconnecting switch 5.

To inform the security services that the short-circuiting switch 80 has been implemented and the building has been secured, a signal is established at the housing 60 and the handle 104. A motion detector 116, installed near the rack 88, can send an indicator 61 placed in the housing 60 an electric signal S₉ representative of the motion of the rack 88. During the implementation of the short-circuiting switch 80, a warning, which can be a light, is displayed by the indicator 61, indicating to the intervention services that the building has been secured.

A mechanical signal is also implemented at the handle 104 using a colored zone 105 formed on the handle. When the handle 104 reaches a low position, corresponding to the low position of the connector bridge 90, the zone 105 is visible through a window 108 formed in a cover 110 containing the short-circuiting switch 80, indicating that the facility has been secured.

In the second, third and fourth embodiments of the invention shown in FIGS. 3 to 5, the elements similar to those of the first embodiment bear the same references. These embodiments generally operate in the same way as before, and in the following, it is primarily what distinguishes them from the first embodiment that is described.

In the embodiment of FIG. 3, the short-circuiting switch 80 comprises an electrically conductive connector bridge 90 controlled by a pneumatic cylinder 182 powered by a pressurized air source formed by a bottle of compressed air 200 equipped with a valve 201. An exhaust valve 183 mounted on the cylinder 182 is controlled from a member 66 arranged in a control housing 60, similar to that of the first embodiment. Two electric conductors 98 transmit a control signal S₈ from the member 66 to the valves 183 and 201. The cylinder 182 is, during normal operation, in the high position, because the valve 201 of the bottle 200 is open and the air keeps the rod of the cylinder in the high position. When a house 1 equipped with a facility 20 of this second embodiment need to be secured, the control member 66 is actuated to open the valve 183 and close the valve 201, such that, under the action of a spring (not shown), the cylinder 182 presses the shoes 94 and 96 of the connector bridge 90 on the electrically conductive tracks 34 and 36 that connect the output terminals 24 and 26 of the photovoltaic generator 22 to the input terminals 44 and 46 of the current converter 42. The cylinder 182 is mounted so that, when it is not powered, the connector is in the low position.

The bottle 200 constitutes an independent energy source for the cylinder 182. It is operational, including when the electric grid specific to the house has been isolated from the public electricity grid. In the event the bottle 200 is empty, the short-circuiting switch 80 automatically establishes the short circuit at the terminals 24 and 26 of the generator 22, because the rod of the cylinder 182 is not kept in the high position by the compressed air.

In the third embodiment of the invention shown in FIG. 4, the short-circuiting switch 80 comprises a pyrotechnic device 282 that makes it possible to press the shoes 94 and 96 of an electrically conductive connector bridge 90 on electrically conductive tracks 34 and 36 that extend between the output terminals 24 and 26 of the photovoltaic generator and the input terminals 44 and 46 of the current converter 42. The lighter 283 of the device 282 is connected to a control member 66 by a conductor 98 that transmits a control signal S₈ making it possible to activate the device 282 if needed, to push the connector bridge 90 against the tracks 34 and 36. The member 66 is situated in a control housing 60 similar to that of the first embodiment.

In the fourth embodiment of the invention shown in FIG. 5, the conductive connector bridge 90 is actuated owing to an insulating stick 382 that makes it possible to exert a force F₂ on that bridge remotely that presses the shoes 94 and 96 on the tracks 34 and 36 that extend between the output terminals 24 and 26 of the generator 22 and the input terminals 44 and 46 of the converter 42. In that case, the lower end of the rod 382 constitutes a control member 66 for the short-circuiting switch 80 thus formed. This end 66, which advantageously bears a handle 68, is situated in or near a housing 60 similar to that of the first embodiment.

In the embodiments of FIGS. 3 to 5, a manual control means, comparable to the handle 104 of the first embodiment, can also be implemented, as emergency control.

Irrespective of the embodiment illustrated in the figures, the short circuiting and maintenance in short circuit of the terminals of the photovoltaic panels 22 by the short-circuiting switch 80 causes the simultaneous short circuiting and maintenance in short circuit of the terminals of the current converter 42 by the electrically conductive connector bridge 90, such that the internal capacitances of that converter are discharged, which prevents those capacitances from constituting sources of potential danger for the emergency services intervening in the house 1.

The member 66 used to control the short-circuiting switch 80 can assume the form of a switch, a magneto or any other form adapted to its function.

The invention has been shown in the case where the facility 20 comprises a single photovoltaic panel 22. In practice, the facility 20 can comprise several such panels, the number of which depends on the desired electric power.

The technical features of the different embodiments mentioned above can be combined in the context of the present invention. In particular, signaling means equivalent to the means 61 and/or 105, as well as the distance d, are applicable to the different embodiments of the invention.

The invention has been described in the case where the connector 90 is translatable relative to the conductive tracks 34 and 36. Alternatively, the contact between the connector bridge 90 and the tracks 34 and 36 can be done by a rotational movement of the connector bridge 90 relative to the tracks 34 and 36. Such a movement can, for example, be done along an axis parallel or perpendicular to the axes of the conductive tracks 34 and 36.

1-13. (canceled)

14. A facility for producing electric current using solar radiation, this facility being built into a building and including at least one photovoltaic generator, and a short-circuiting switch suitable for establishing and maintaining a short-circuit across the terminals of the photovoltaic generator, wherein this short-circuiting switch is adapted to maintain the short circuit using an electrically conductive connector bridge, and in that the short-circuiting switch is activated by a control means arranged in a predetermined portion of the building or the surroundings thereof.

15. The facility according to claim 14, wherein the predetermined portion of the building also contains means for monitoring the supply of current from a public distribution grid for electric current.

16. The facility according to claim 14, wherein the predetermined portion of the building also contains means for monitoring the supply of gas from a public gas distribution grid or a tank.

17. The facility according to claim 14, wherein the facility also comprises a converter for converting direct current into alternating current and in that the short-circuiting switch is mounted so that it establishes or maintains simultaneously, using the electrically conductive connector bridge, the short circuit across the terminals of the photovoltaic generator and across the terminals of the current converter.

18. The facility according to claim 14, wherein the short-circuiting switch is actuated from an energy source distinct from the energy grid of the building.

19. The facility according to claim 18, wherein the energy source is electric and the short-circuiting switch comprises an electric actuator powered from that source.

20. The facility according to claim 19, wherein the electric energy source is supplied with current by the photovoltaic generator during normal operation of the facility.

21. The facility according to claim 20, wherein the energy source is pneumatic and the short-circuiting switch comprises a pneumatic actuator powered from that source.

22. The facility according to claim 14, wherein the short-circuiting switch mechanically actuated by a member connected to the aforementioned control means or by a member that can be actuated locally, close to the short-circuiting switch.

23. The facility according to claim 14, wherein it comprises means for signaling the implementation of the short-circuiting switch.

24. The facility according to claim 23, wherein the signaling means is arranged in the predetermined portion of the building.

25. The facility according to claim 23, wherein the signaling means is arranged close to the short-circuiting switch.

26. A method for securing a building equipped with a facility for producing electric current from the solar radiation, comprising at least one photovoltaic generator, wherein it comprises a step consisting of establishing and maintaining, using an electrically conductive connector bridge, a short circuit across the terminals of the photovoltaic generator.
